(19) United States
(12) Patent Application Publication
(10) Pub. No.: US 2026/0121715 A1
(43) Pub. Date: Apr. 30, 2026

(54) Ultra High Reliability (UHR) Physical layer Protocol Data Unit (PPDU) for Coordinated Beamforming Transmissions

(71) Applicant: NXP USA, Inc., AUSTIN, TX (US)

(72) Inventors: Hari Ram Balakrishnan, Chennai (IN); Sudhir Srinivasa, Los Gatos, CA (US); Rui Cao, Sunnyvale, CA (US); Liwen Chu, San Ramon, CA (US)

(21) Appl. No.: 19/368,408

(22) Filed: Oct. 24, 2025

(30) Foreign Application Priority Data
Oct. 25, 2024 (IN) 202441081341

(51) Int. Cl. H04B 7/06; H04L 1/00; H04L 69/323

(52) U.S. Cl. CPC H04B 7/0617; H04L 1/0003; H04L 69/323

(57) ABSTRACT

A coordinated beamforming (CBF) includes transmitting, by a sharing access point (AP), a trigger frame to a shared access point; generating, by the sharing AP and shared AP, based on preamble field data of the trigger frame a respective physical layer protocol data unit (PPDU) wherein the preamble field data are populated in fields of a preamble of the respective PPDU; and wherein the preamble field data are negotiated between the sharing AP and shared AP prior to generating the PPDU; and transmitting, by the sharing AP and shared AP, simultaneously in time and frequency the respective PPDU to perform the CBF, wherein the preamble field data in the populated fields of the preamble of the respective PPDU transmitted by the sharing AP and shared AP are the same.

### CROSS-REFERENCE TO RELATED APPLICATIONS

This application is entitled to the benefit of Indian Provisional Patent Application Serial Number IN 202441081341, titled “UHR CBF preamble design consideration” which was filed Oct. 25, 2024, the content of which is incorporated herein by reference in its entirety.

### FIELD OF USE

The present disclosure relates generally to coordinated beamforming (CBF), and more particularly, to a system, method, and apparatus for defining preamble field data of a preamble of a physical layer protocol data unit (PPDU) compliant with Institute of Electrical and Electronics Engineers (IEEE) 802.11bn or Ultra High Reliability (UHR) used in CBF transmissions.

### BACKGROUND

Beamforming is a signal processing technique used in wireless communication and other systems to focus a transmitted signal in a specific direction, rather than broadcasting the transmitted signal in all directions. By directing transmission of the signal in the specific direction, signal reception at a receiver is improved and interference with receivers not intended to receive the signal is less. To achieve beamforming, transmissions by multiple antennas of a wireless device are combined to form a coherent beam traveling in the specific direction and an electrical field is rotated to control this direction. Institute of Electrical and Electronics Engineers (IEEE) 802.11bn or Ultra High Reliability (UHR) defines a Multi-AP coordination process where multiple independent access points (APs) coordinate transmissions to associated client stations (STA) to improve network performance. Coordinated beamforming (CBF) is one example of the multi-AP coordination where interference between the transmissions by a plurality of APs is reduced by the plurality of APs using beamforming to simultaneously transmit physical layer protocol data units (PPDUs) to associated STA.

### BRIEF DESCRIPTION OF THE DRAWINGS

The following detailed description of the preferred embodiments of the present disclosure will be better understood when read in conjunction with the appended drawings. The present disclosure is illustrated by way of example, and not limited by the accompanying figures, in which like references indicate similar elements.

FIG. 1 illustrates an example block diagram of a wireless network arranged to perform coordinated beamforming (CBF) in accordance with one or more embodiments.

FIG. 2 illustrates example communication between a sharing access point (AP) and shared AP to enable the CBF in accordance with one or more embodiments.

FIGS. 3(a)-3(e) illustrate example fields of a preamble of a physical layer protocol data unit (PPDU) that are configured by the sharing AP or the shared AP in accordance with one or more embodiments.

FIG. 4 is an example flow chart of functions for configuration of the fields of the preamble of the PPDU in accordance with one or more embodiments.

### DETAILED DESCRIPTION

The detailed description of the appended drawings is intended as a description of the currently preferred embodiments of the present disclosure, and is not intended to represent the only form in which the present disclosure may be practiced. It is to be understood that the same or equivalent functions may be accomplished by different embodiments that are intended to be encompassed within the spirit and scope of the present disclosure.

A WiFi network includes a plurality of access points (APs) including a sharing AP and a shared AP where each AP transmits respective PPDUs to associated client stations (STAs) in the WiFi network. The sharing AP is an owner of a transmit opportunity (TXOP) and allows other shared APs to use the TXOP of the sharing AP to transmit PPDUs to associated STA of the shared AP. The APs transmit PPDUs to associated STA based on a coordinated beamforming (CBF) to reduce interference between transmissions of an AP to associated STAs. One AP in a basic service set (BSS) and another AP in a overlapping basic service set (OBSS) cooperate such that an OBSS AP which transmits a physical layer protocol data unit (PPDU) to its associated STA by beamforming also transmits a null spatial beam in a direction of an associated STA of the AP in the BSS thereby enabling the BSS AP to communicate with one or more of its associated stations with reduced interference in the TXOP simultaneously in time and in frequency. Similarly, the AP in the BSS transmits a null beam in a direction of an associated STA of the AP in the OBSS thereby enabling the OBSS AP to communicate with one or more of its associated stations with reduced interference in the TXOP simultaneously in time and in frequency.

Embodiments disclosed herein are directed to defining preamble field data of a preamble of a physical layer protocol data unit (PPDU) transmitted by the APs to perform CBF by the sharing AP and shared AP. A trigger frame is sent from a sharing AP to the shared AP with preamble field data of the preamble. The shared AP receives this trigger frame and based on the preamble field data of the trigger frame and preamble field data defined by the shared AP (and not indicated in the trigger frame) the shared AP generates a PPDU with a preamble. The sharing AP also generates a PPDU based on the preamble field data included in the trigger frame and preamble field data defined by the sharing AP where the preamble field data of the preamble of the PPDUs generated by the sharing AP and shared AP are the same. Each AP then transmits its respective PPDU based on a coordinated beamforming (CBF) to associated STA simultaneously in time and frequency. The associated STA receives a PPDU and decodes the PPDU based on the preamble field data of the preamble. Well known instructions, protocols, structures, and techniques have not been shown in detail in order not to obfuscate the description.

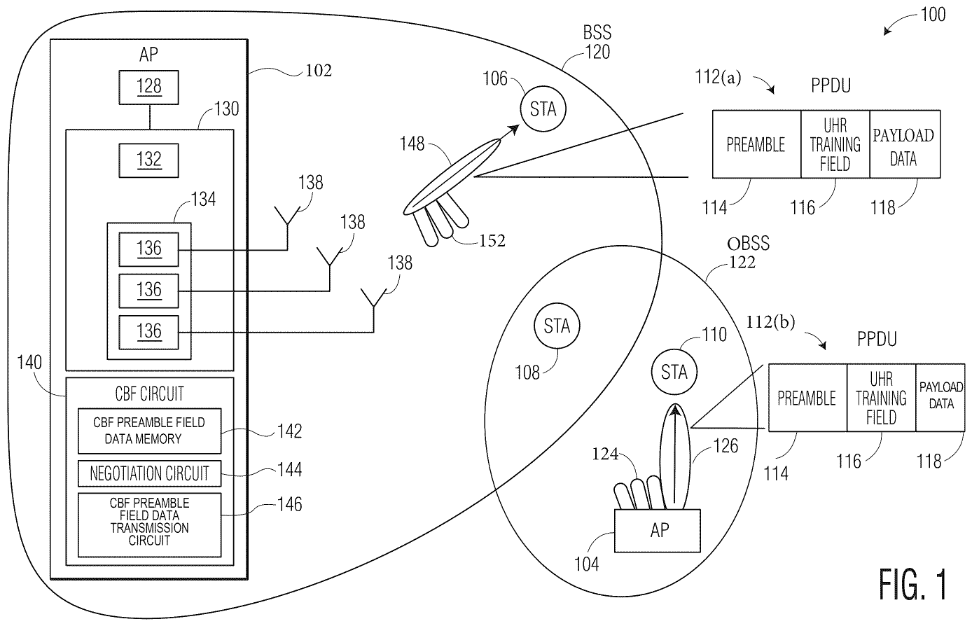

FIG. 1 illustrates an example block diagram of a wireless network 100 arranged to perform coordinated beamforming (CBF) in accordance with one or more embodiments. The wireless network 100 includes two access points (APs) 102, 104 each associated with a station (STA). For example, AP 102 has STA 106 associated and AP 104 has STA 110 associated. The wireless network 100 may include more than two APs and more than one associated stations for each AP and the number of APs and stations shown in the wireless network 100 is for illustrative purposes only. In an embodiment, the station (STA) is a fixed or mobile wireless terminal and the AP may be a networking device which facilitates a connection of the station to a wired network (not shown). The AP or STA may also be referred to generally as wireless devices. An access point (AP) may communicate with one or more associated stations in a downlink or uplink direction. The downlink (i.e., forward link) direction is a communication from the access point to the stations, and the uplink (i.e., reverse link) direction is a communication from the stations to the access point. A station is associated with an AP when it has successfully connected to and is communicating with the AP based on an association process which includes the station sending an association request to the AP and the AP responding with an association response as defined by Institute of Electrical and Electronics Engineers (IEEE) 802.11.

The AP 102 includes a host processor 128 coupled to a network interface 130. The host processor 128 may enable the AP 102 to transmit and receive signals as described herein. The network interface 130 includes a medium access control (MAC) processing unit 132 and a physical layer (PHY) processing unit 134. The PHY processing unit 134 includes a plurality of transceivers 136 (e.g., transmitters and/or receivers) and the transceivers 136 are coupled to a respective antenna 138 for transmitting or receiving wireless signals. Although three transceivers and three antennas are illustrated, the AP 102 includes other suitable numbers (e.g., 1, 2, 4, 5, etc.) of transceivers and antennas in other embodiments. In one or more embodiments, the MAC processing unit 132 and the PHY processing unit 134 are configured to operate according to a communication protocol such as Institute of Electrical and Electronics Engineers (IEEE) 802.11 WiFi standard. Although not shown, the AP 104 and STA 106, 110 may have similar structure and components including a processor and a network interface. The wireless devices and components described therein to perform the described functions herein may be implemented as one or more of analog circuitry, mixed signal circuitry, memory circuitry, logic circuitry, and processing circuitry that execute code stored in a memory that when executed by the processing circuitry performs the disclosed functions.

Each AP may be identified as either a sharing AP or shared AP. For example, AP 102 may be a sharing AP while AP 104 may be a shared AP. The sharing AP may be an access point which shares a bandwidth of a wireless medium and associated resources such as a transmit opportunity (TXOP) with the one or more shared AP in addition to facilitating communication with an associated station. The shared AP uses the shared bandwidth of the wireless medium and shared resource to facilitate communication with an associated station. TXOP or Transmission Opportunity, is a bounded time interval where a connected station is able to transmit a sequence of frames consecutively without interruption to associated stations. The sharing AP is an owner of a transmit opportunity (TXOP) and allows other shared APs to use the TXOP of the sharing AP to transmit data during the TXOP.

The APs 102, 104 may each beamform signals transmitted to an associated STA. Beamforming is a signal processing technique used in wireless communication and other systems to focus a transmitted signal in a specific direction, rather than broadcasting the transmitted signal in all directions. Transmissions of each of the antenna 138 may be weighted to focus the transmitted signal in the specific direction and improve signal reception at a receiver. The APs 102, 104 may perform beamforming compliant with Institute of Electrical and Electronics Engineers (IEEE) 802.11bn or Ultra High Reliability (UHR). IEEE 802.11bn or UHR defines a Multi-AP coordination process where multiple independent APs coordinate transmissions to improve network performance, including using coordinated beamforming or coordinated spatial reuse.

In one or more embodiments, AP 102 of a basic service set (BSS) 120 may transmit to associated STA 106 while AP 104 transmits to associated STA 110 in a different BSS 122. A BSS may be a group of one or more STA associated with an AP where STAs communicate with the AP. The wireless network 100 may have a plurality of BSS 120, 122 where one BSS 120 may overlap with another BSS 122 (referred to as an overlapping BSS or OBSS 122) and the transmission by the AP 104 in the OBSS 122 may normally interfere with the transmission by the AP 102 in the BSS 120. In one or more embodiments, the AP 102 and associated STA 106 define the basic service set (BSS) 120 and the AP 104 and associated STA 110 define an overlapping basic service set (OBSS) 122. The BSS 120 and OBSS 122 may coordinate transmissions to reduce interference in transmissions. Coordinated beamforming (CBF) is one example of a multi-AP coordinated transmission where a plurality of APs transmit simultaneously in time and in frequency to associated STA using beamforming while also reducing interference between the transmissions of the plurality of APs. For example, if an AP 102 in the BSS 120 is transmitting to associated STA 106 and the AP 104 in the OBSS 122 is transmitting to associated station 110, the AP 104 in the OBSS 122 transmits null spatial beam 124 in a direction of the STA 106 which may receive transmissions from the AP 102 in the BSS 120. Further, the AP 102 in the BSS 120 transmits a null spatial beam 152 in a direction of the STA 110 which may receive transmissions from the AP 104 in the OBSS 122. As a result, the BSS AP 102 is able to communicate with one or more of its associated stations 106 by beam 148 with reduced interference in the TXOP and the OBSS AP 104 is able to communicate with one or more of its associated stations 110 by beam 126 with reduced interference in the TXOP based on the null spatial beam 152, 124 transmissions. The null spatial beams cancel or reduce signals in an undesired direction which is the source of the interference by adjusting antenna array weights to create a deep null in the direction. In one or more embodiments, the null spatial beam 124 reduces interference based on the transmission of the main beam 126 and the null spatial beam 152 reduces interference based on the main beam 148 so that STA 106 and STA 110 experiences less interference. The beamforming is coordinated by the APs to reduce the interference at an STA.

In one or more embodiments, the CBF transmission between an AP and associated STA may be a physical layer protocol data unit (PPDU) transmitted from an AP to associated STA. Shared AP 104 may transmit a PPDU 112(b) to associated STA 110 while sharing AP 102 may transmit a PPDU 112(a) to associated STA 106. The PPDU 112(a), 112(b) defined by IEEE 802.11 UHR may each have a preamble 114, a UHR training field 116, and a payload data field 118 to facilitate CBF transmissions. The data in the payload data field 118 of a PPDU may be transmitted by an AP to associated STA using beamforming while transmitting a null spatial beam in directions of other STA associated with another AP transmitting at a same time and frequency to its associated other STA to reduce interference in the direction of the other STA. A precoding is applied to the PPDU to beamform certain fields of the PPDU. The precoder is a signal processing technique in multi-antenna wireless communication systems that uses a matrix multiplication to transform transmitted signals before they are sent, effectively optimizing their path (e.g., direction) to a specific station.

Embodiments disclosed herein are directed to defining field data of respective fields of the preamble 114 of the PPDU 112(a), 112(b) associated with coordinated beamforming (CBF) in the wireless network 100. A sharing AP 102 may have a CBF circuit 140 to facilitate the CBF. The CBF circuit 140 is arranged to cause the shared AP 104 to transmit the PPDU 112(b) to associated STA with certain preamble field data in the preamble 114 of the PPDU 112(b). Further, the sharing AP 102 may transmit the PPDU 112(a) to associated STA with same preamble field data in the preamble 114 as the PPDU 112(b). A recipient of the PPDU may use the preamble field data to facilitate decoding of the PPDU transmitted by CBF which could include an STA associated with the shared AP 104. The payload data field 118 of the PPDU may be beam steered by the AP 104 in a direction of an associated STA by a precoding but no precoding may be applied to the preamble 114 so that the preamble field data of the preamble 114 are transmitted omnidirectionally and other wireless devices in a communication range of the AP such as station 108 not associated with AP 102, 104 is able to receive the preamble field data of the preamble 114 of the PPDU. This allows other wireless devices in a communication range of the AP 102, 104 such as station 108 to decode the preamble 114 and determine that a PPDU has been transmitted from an AP. The station 108 may then refrain from transmitting while an AP transmits the PPDU during a TXOP which would otherwise interfere with the communication by the AP.

In one or more embodiments, the CBF circuit 140 may have a memory such as CBF preamble field data memory 142 to store the preamble field data which is then included in the preamble 114 of the PPDU 112(a) transmitted by AP 102 and the PPDU 112(b) transmitted by AP 104. Each AP may transmit a PPDU 112(a), 112(b) carrying respective data of the AP in a payload data field 118 of the PPDU 112. Preamble field data of the preamble 114 of the PPDUs 112(a), 112(b) may be the same among APs so respective PPDU 112(a), 112(b) may be transmitted simultaneously in time and frequency during a TXOP by different APs and the preamble field data of the preambles of the PPDUs do not interfere with each other. The transmission of the same preamble field data in the preamble 114 of the PPDU 112(a), 112(b) by different APs 102, 104 allows other wireless devices in a communication range of the AP 102, 104 such as station 108 not associated with an AP 102, 104 to reliability receive the preamble fields data of the preamble 114 of the PPDU 112(a), 112(b) (i.e., preambles of PPDUs transmitted by different AP 102, 104 do not interfere), decode the preamble field data of the preamble 114 and determine that a PPDU has been transmitted from an AP 102, 104. The station 108 may then refrain from transmitting while an AP 102, 104 transmits the PPDU during a TXOP which would otherwise interfere with the communication by the AP 102, 104.

In one or more embodiments, the CBF circuit 140 of the sharing AP 102 may further facilitate transmitting preamble field data of the preamble 114 from the sharing AP 102 to the shared AP 104 which is used by the shared AP 104 to generate the PPDU 112(b) with the preamble 114 of the PPDU 112(b) having the preamble field data. The sharing AP 102 may have a CBF preamble field data transmission circuit 146 to facilitate sending to the shared AP 104 the preamble field data to be included in the preamble 114 of the PPDU 112(b) which causes the shared AP 104 to generate PPDU 112(b) in accordance with CBF based on the preamble field data received from the sharing AP 102. In an embodiment, the preamble field data may be values of one or more preamble fields of the PPDU. The sharing AP 102 may also generate the PPDU 112(a) with the preamble 114 having the same preamble field data. Each AP transmits a respective PPDU based on a coordinated beamforming (CBF) to associated STA and the associated STA receives the PPDU 112(a), 112(b) and decodes the PPDU 112(a), 112(b) based on the preamble field data of the preamble 114. In one or more embodiments, the CBF circuit 140 of the sharing AP may also have a negotiation circuit 144 to allow the sharing AP 102 to negotiate with the shared AP 104 certain preamble field data to be included in the preamble 114. In one or more embodiments, the negotiation by the negotiation circuit 144 may include the sharing AP 102 requesting from the shared AP 104 suggested field data for a field of the preamble 114 and the shared AP 104 providing the suggested field data for the field of the preamble 114 to the sharing AP 102 which is either accepted or rejected by the sharing AP 102.

In some embodiments, a sharing AP and two or more shared AP may transmit respective PPDU in a TXOP simultaneously in time and frequency in accordance with CBF to associated STA. Preamble field data of the preamble 114 of the PPDU transmitted by each of the APs may be the same to allow for station 108 which is not associated with the transmitting APs to be able to receive the preamble 114, detect a transmission of the PPDU, and refrain from transmitting while an AP transmits the PPDU during a TXOP which would otherwise interfere with the communication by the AP. Further, each of the shared AP 104 may also have a CBF circuit including preamble field data memory and a negotiation circuit among other circuits to perform functions similar to the sharing AP 102.

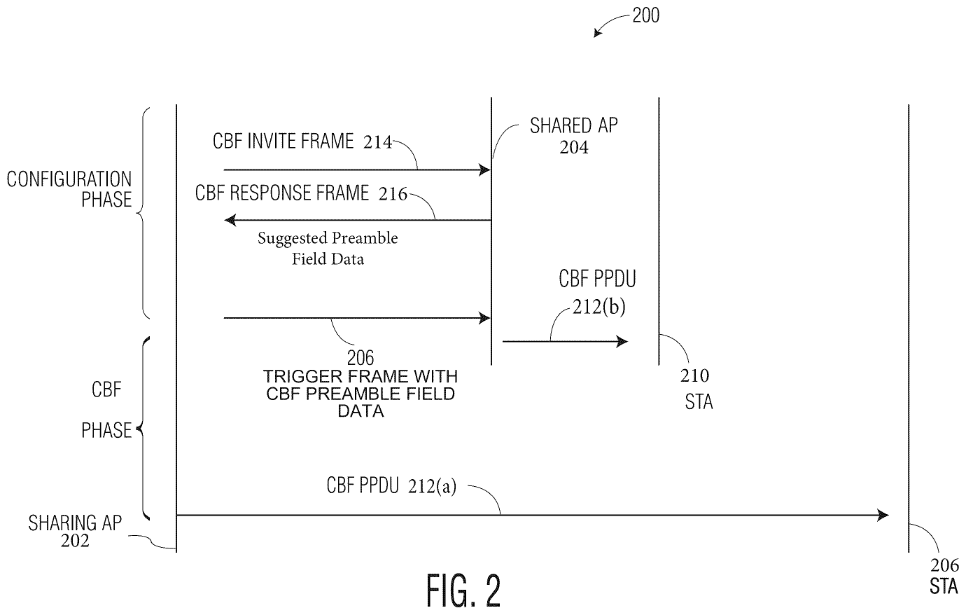

FIG. 2 illustrates example communication 200 between the sharing AP 210 and shared AP 204 to enable the CBF in accordance with one or more embodiments. The sharing AP 202 may reserve the communication medium and share a TXOP with a shared AP 204. Then, the sharing AP 202 may enter into a configuration stage to define the preamble field data of the preamble 114 of the PPDU later transmitted by the AP 102, 104 to associated STA in CBF. The preamble field data which are defined are described in further detail below. In the configuration phase, the sharing AP 202 may negotiate with the shared AP 204 certain preamble field data of preamble 114 of the PPDU. In an embodiment, IEEE 802.11 defines a process for one AP to request capability of another AP. For example, when one AP (the “sharing AP”) initiates a coordinated beamforming session, it sends a CBF invite frame 214 defined by IEEE 802.11 to another AP (the “shared AP”) to determine its readiness to establish the preamble field data for the coordinated beamforming session. The CBF invite frame 214 causes the shared AP 204 to transmit to the sharing AP 202 a CBF response frame 216 defined by IEEE 802.11 to indicate its readiness to feed back the preamble field data for the coordinated transmission. In one or more embodiments, the CBF invite frame 214 may be a control frame such as an initial control frame (ICF) defined by IEEE 802.11 to request that the shared AP 204 provide suggested preamble field data for the preamble 114 of the PPDU for CBF. For example, the request for the suggested preamble field data may be indicated in an information field of the CBF invite frame 214. In one or more embodiments, the CBF response frame 216 may be a control frame such an initial control response (ICR) frame defined by IEEE 802.11 with the suggested preamble field data of the preamble 114 provided by the shared AP 204. For example, the suggested preamble field data may be indicated in an information field of the CBF response frame 216 and be field data for a portion of the fields of the preamble 114, all of the fields of the preamble 114, or none of the fields of the preamble 114. The sharing AP 202 may select to use the suggested preamble field data indicated by the shared AP 204 or a portion thereof or none and define new preamble field data for the field data not selected. The transmission of the CBF invite frame 214 by the sharing AP and the transmission of the CBF response frame 216 by the shared AP results in the APs negotiating preamble field data of the preamble 114. The sharing AP 202 may then construct a trigger frame 206 to specify the preamble field data of the preamble 114 of the PPDU for CBF. In an embodiment, the trigger frame 206 defined by IEEE 802.11 may carry certain preamble field data indicated by the shared AP 204 and certain preamble field data indicated by the sharing AP 202 and other fields of the PPDU. For example, the preamble field data may be indicated in an information field of the trigger frame 206. The sharing AP 202 may then transmit the trigger frame 206 to the shared AP 204 which in some embodiments further facilitates a synchronization between APs. In some embodiments, an AP and its associated STA(s) may exchange additional ICF and ICR frames after the exchange of the CBF invite frame 214 and CBF response frame 216 between APs or between the CBF invite frame 214 and CBF response frame 216 to facilitate subsequent transmission of the trigger frame 206 and the CBF PPDU 212. Based on the received trigger frame 206 and in a CBF phase, the shared AP 204 may responsively generate and transmit a PPDU (i.e., PPDU 212(b)) to associated STA 210 with fields of the preamble 114 of the PPDU defined in part or in whole by the preamble field data carried in the trigger frame 206 and/or predefined preamble field data stored the preamble field data memory 142 and not included in the trigger frame 206. Further, the sharing AP 202 in the CBF phase may transmit a PPDU (i.e., PPDU 212(a)) to the STA 206 with fields of a preamble 114 also defined by the preamble field data. In one or more embodiments, preamble field data of the preamble 114 may be the same for PPDUs transmitted by different AP while the PPDU transmitted by each AP may carry respective data in the payload data field 118. Each AP may transmit the respective PPDU to an associated STA during the TXOP. A precoding may not be applied to the preamble 114 so that other STA located omnidirectional to a transmitting AP such as STA 108 are able to receive the preamble 114 and refrain from transmitting during the TXOP. Further, a null spatial beam may be transmitted by one AP in a direction that another AP is transmitting to reduce interference between the other AP and associated stations. The payload data field 118 of each PPDU may be beamformed in a direction of associated STA of the transmitting AP.

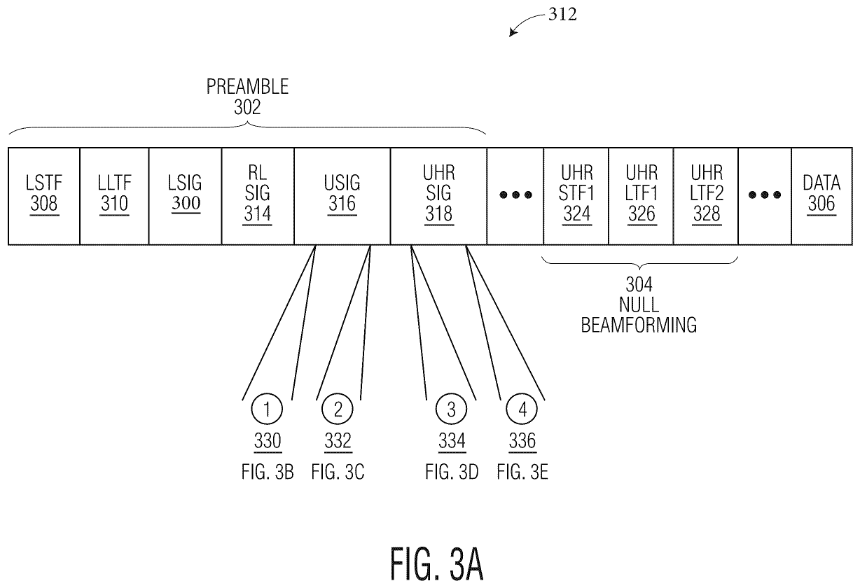

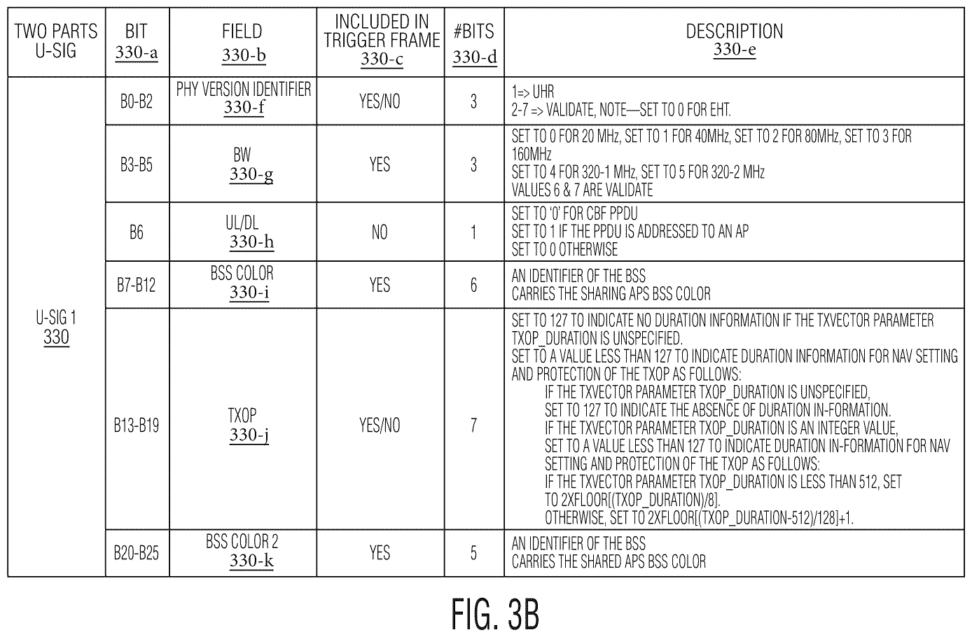

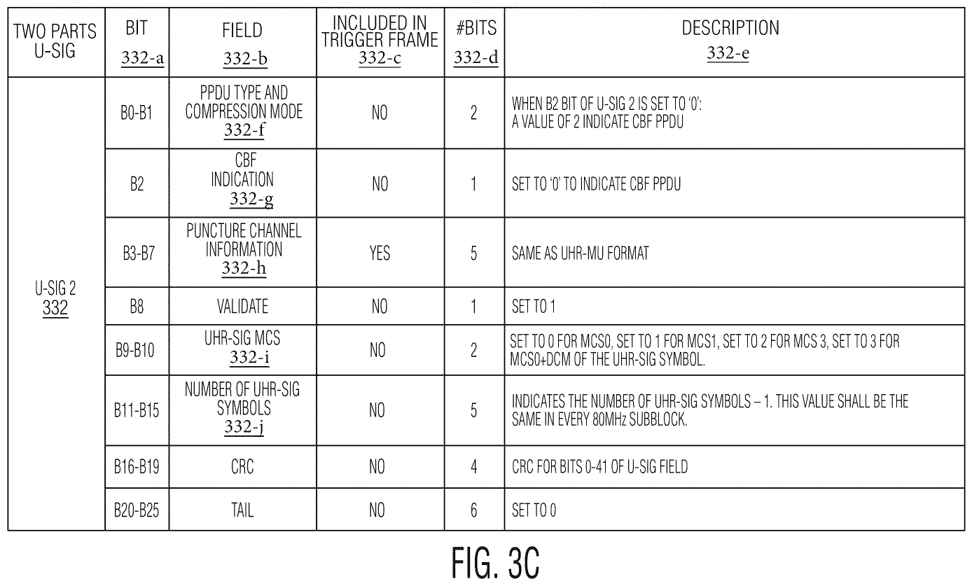

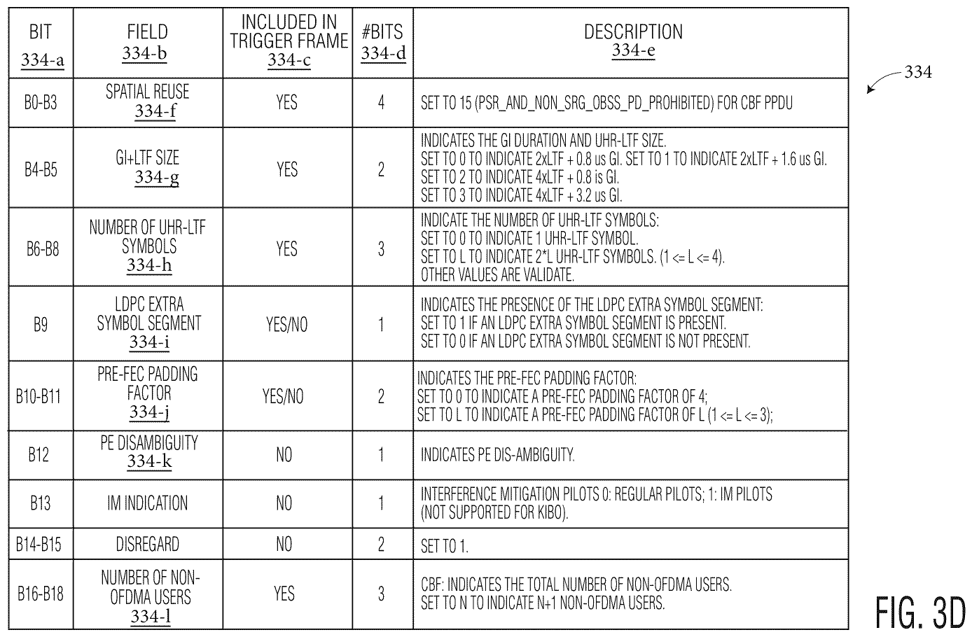

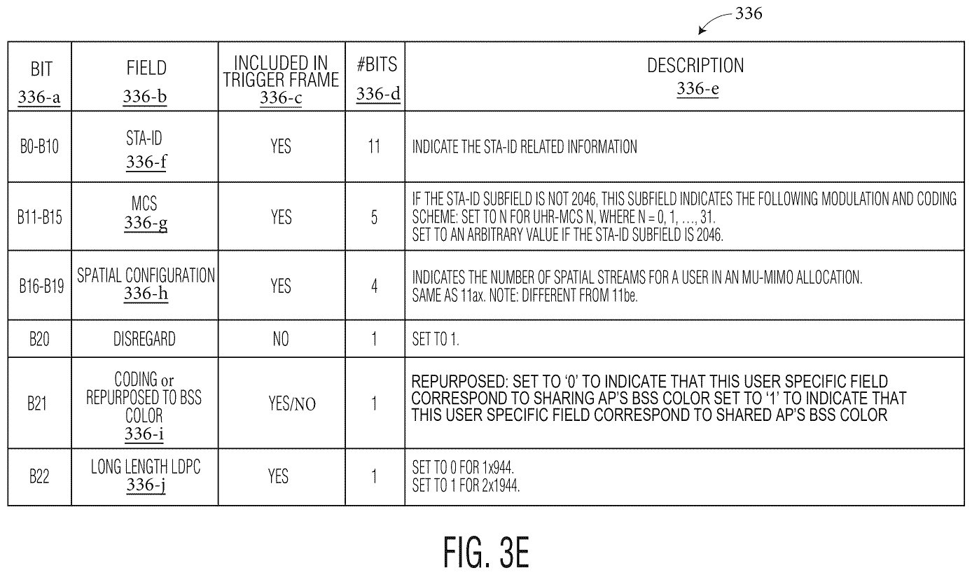

FIGS. 3(a)-3(e) illustrate example fields of a preamble 302 of the PPDU 312 that are configured by the sharing AP 102 or the shared AP 104 in accordance with one or more embodiments. Field data of fields in the preamble 302 of the PPDU 312 defined by IEEE 802.11bn may be transmitted by the sharing AP 102 and the shared AP 104 to generate the preamble 302 of the PPDU for performing CBF.

The preamble 302 includes a plurality of subfields 306-328 such as a legacy short training field (LSTF) 308, a legacy long training field (LLTF) 310, a legacy signaling field (LSIG) 300, an extended legacy signaling field (RLSIG) 314, a user signal field (USIG) 316, and a UHR SIG field 318 defined by IEEE 802.11 UHR. The training fields may be training sequences for an STA to synchronize with a received signal while the signaling fields may define field data for decoding data in a data field 306 of the PPDU 312. The sharing AP 102 may transmit preamble field data of the preamble 302 to the shared AP 104 in the trigger frame 206 which then causes the shared AP 104 to generate a PPDU 312 having the preamble field data in the preamble 302 and which is transmitted in accordance with CBF. The sharing AP 102 may also generate a PPDU with a preamble 302 having the same preamble field data.

The preamble 302 may include an LSIG field 300. The LSIG field 300 may include a length field. The length field may indicate a length of the PPDU 312. The sharing AP 102 may define the length and include this indication of length in the trigger frame 206 transmitted to the shared AP 104. The shared AP 104 and the sharing AP 102 may use this indicated length to populate the LSIG field 300 and generate the PPDU 312 in accordance with CBF and having the indicated length.

The PPDU 312 also includes an ultra-high reliability (UHR) short training field 324 and a plurality of UHR long training fields 326-328. A precoding may be applied by the transmitting AP to these fields to perform a null beamforming 304 in a direction of an STA to reduce interference by the transmitting AP.

The preamble 302 may include the USIG field 316. The USIG field 316 includes a USIG-1 subfield 330 and a USIG-2 subfield 332 each with a plurality of fields. Each subfield of the USIG field 316 includes a plurality of bits. Bit locations are identified in column 330-a, the corresponding field name is identified in column 330-b, and the number of bits in the field is defined in column 330-d. A description of the field and setting is defined in column 330-e and an indication of whether field data of a field 330-b are indicated in a trigger frame 206 transmitted from the sharing AP 102 to the shared AP 104 is defined in column 330-c. A “yes” in column 330-c indicates that the field data is included in the trigger frame 206, a “no” indicates that the field data is not included in the trigger frame 206, and “yes/no” indicates that the field data could be or could not be included in the trigger frame 206 depending on a configuration of the sharing AP 102 and shared AP 104.

Field data of fields of the USIG field 316 are transmitted by the sharing AP 102 to the shared AP 104 in the trigger frame 206. The USIG-1 subfield 330 include a phy version identification field 330-f, a PPDU bandwidth field 330-g, and a TXOP field 330-j. The field data of the phy version identification field 330-f indicates a version of the WiFi corresponding to the PPDU 312 which is UHR and the field data for the PPDU bandwidth field 330-g indicates a bandwidth of the PPDU 312. Further, the field data of the TXOP field 330-j may be set to 127 to indicate that the TXOP duration is an undefined value. The field data of the USIG-2 subfield 332 transmitted from the sharing AP 102 and shared AP 104 include punctured channel information indicating punctured channels and defined in the punctured channel information field 332-h. The sharing AP 102 may transmit one or more of these field data to the shared AP 104 in the trigger frame 206. In some embodiments, the field data of the phy version identification field 330-f and TXOP field 330-j may be predefined, stored in a respective preamble field data memory 142 of the sharing AP 102 and shared AP 106 as part of an initialization process, and not communicated between the sharing AP 102 and shared AP 106 or included in the trigger frame 206. The predefined field data may also be the same for the shared AP 106 and sharing AP 102. The shared AP 104 may populate respective fields of the preamble 302 of the PPDU 312 to generate the PPDU 312 based on the received trigger frame 206 for transmission in accordance with CBF. Further, the sharing AP 102 may generate the preamble 302 of the PPDU 312 also based on the preamble field data for transmission in accordance with CBF.

The USIG-1 subfield 330, 332 includes the UL/DL field 330-h which indicates a direction of communication uplink to an AP or downlink to a STA for a CBF PPDU, a PPDU type field 332-f, modulation and coding scheme (MCS) field 332-i, a CBF indication field 332-g, and number of UHR-SIG symbol field 332-j which indicate a number of UHR-SIG symbols. Field data for these fields may not be transmitted by the sharing AP 102 to the shared AP 104 in the trigger frame 206 because the field data may be predefined, stored in a respective preamble field data memory 142 of the sharing AP 102 and shared AP 106 as part of an initialization process, and not communicated between the sharing AP 102 and shared AP 106 or included in the trigger frame 206. The predefined field data may also be the same for the shared AP 106 and sharing AP 102. The uplink/downlink field 330-h may be set to 0 or downlink to indicate a downlink communication, a PPDU type field 332-h which is 2 bits may be set to indicate a CBF when the B2 of the U-SIG 2 subfield 332 is set to zero, a modulation and coding scheme (MCS) field 332-i may be set to MCS=0 to indicate the modulation and coding scheme for the UHR-SIG symbol 334, 336. The number of UHR-SIG symbols field 332-j may be set based on a number of users which the shared AP and sharing AP communicates. The number of users or recipients of the PPDU of the CBF may be negotiated between the sharing AP 102 and shared AP 104 in one or more embodiments. The CBF field 332-g may also be set to indicate that the PPDU 312 is a CBF PPDU. The sharing AP 102 and shared AP 104 may use the preamble field data to populate the preamble 302 of the PPDU 312 which is transmitted in accordance with CBF.

A BSS color may indicate a numerical identifier or “color,” to each Basic Service Set (BSS) to help devices distinguish between their own transmissions and those from neighboring, overlapping BSSs (OBSSs) on the same channel. The USIG-1 subfield 330 in the PPDU 312 of the CBF transmission may also include one or more basic service set (BSS) color fields. In one or more embodiments, the BSS color field 330-i which is defined by bits 7-12 of the USIG-1 subfield 330 may define a BSS color of the sharing AP 102. The sharing AP 102 may define in the trigger frame 206 field data of the BSS color field 330-i of the sharing AP 102. The sharing AP 102 and the shared AP 104 may use the field data to populate the BSS color field 330-i and generate respective PPDU 312 in accordance with CBF. In one or more embodiments, the USIG-1 subfield 330 may not indicate a BSS for the shared APs 104. In one or more embodiments, a PPDU 312 received by STAs associated with the shared AP 104 may be arranged to receive and decode the PPDU 312 having a BSS color of the sharing AP 102 for the current TXOP resulting in no need to indicate the BSS color of the shared AP 104.

In one or more embodiments, the USIG-1 subfield 330 may indicate a BSS color for the shared AP 102. The sharing AP 102 may define in the trigger frame 206 field data for this USIG-1 subfield 330 which is used to by the shared AP 104 to generate the PPDU 312. Bits 20-25 of the USIG-1 subfield 330 may be undefined in the PPDU 312. These bits are redefined to be a BSS color 2 field 330-k and indicates a BSS identifier. The preamble field data of the trigger frame 206 may indicate that the BSS color 2 field 330-k is to indicate the BSS color of the shared APs. The sharing AP 102 and shared AP 104 may use the preamble field data to populate the preamble 302 of a respective CBF PPDU 312 which is then transmitted.

In one or more embodiments, the STA which receives the PPDU 312 may decode the BSS color field 330-i. If the STA does not support CBF, the STA decodes the BSS color field 330-i and stops decoding the PPDU 312 unless the associated AP of the STA has the BSS color of the sharing AP 102. If the station supports CBF, then the STA may check the BSS color of the shared AP 104 in the BSS color 2 field 330-k and BSS color of the sharing AP 102 in the BSS color field 330-i against its associated AP's BSS color. If there is a match, then the STA receives and decodes the PPDU 312 accordingly (e.g., decodes the PPDU). If there is not a match, then the STA stops decoding the PPDU 312. If the BSS of the AP associated with the STA matches the BSS of the sharing AP 102, then the STA may be able to transmit to the sharing AP 102 and not the shared AP 104 while if the BSS of the AP associated with the STA matches the BSS of the shared AP 104, then the STA may be able to transmit to the shared AP 104 and not the sharing AP 102. The STA in a BSS may define an intra network allocation vector (NAV) timer to facilitate transmission to the associated AP in a same BSS without interference by other devices in the BSS and define an inter NAV timer to facilitate transmission to the associated AP in a same BSS without interference by other devices in an OBSS.

The PPDU 312 may include a UHR USIG field 318 with a UHR USIG Overflow subfield 334 and UHR SIG user information content subfield 336 in the UHR USIG field 318 each with a plurality of fields. Each field of the UHR USIG field 318 includes a plurality of bits. A bit location is identified in column 334-a, the corresponding field is identified in column 334-b, the number of bits in the field is defined in column 334-d. Further, a description of the field and setting is defined in column 334-e along with an indication of whether field data of a field are indicated in a trigger frame 206 transmitted from the sharing AP 102 to the shared AP 104 in column 334-c.

The fields of the UHR USIG Overflow subfield 334 may include a guard interval and long training size subfield 334-g, a low density parity check code (LDPC) extra symbol subfield 334-i, a pre-forward error correction (FEC) padding factor subfield 334-j, and a number of non-OFMDA users field 334-1. Field data of the UHR USIG Overflow subfield 334 communicated from the sharing AP 102 to the shared AP 104 in the trigger frame 206 may include a duration of a guard interval followed by a long training field, a low density parity check code (LDPC) extra symbol segment, a pre-forward error correction (FEC) padding factor, and an indication of the number of OFDMA users of the sharing AP for respective fields in the UHR USIG Overflow subfield 334. In one or more embodiments, the LDPC extra symbol segment subfield 334-i may be set to one to indicate an LDPC extra symbol will be included in the PPDU and the Pre-FEC padding factor subfield 334-j may be set to four. In some embodiments, the field data of the Pre-FEC padding factor subfield 334-j and LDPC extra symbol segment subfield 334-i may not need to be communicated from the sharing AP 102 to the shared AP 104 in the trigger frame 206 because the field data may be predefined, stored in a respective preamble field data memory 142 of the sharing AP 102 and shared AP 106 as part of an initialization process, and not communicated between the sharing AP 102 and shared AP 106 or included in the trigger frame 206. The predefined preamble field data may also be the same for the shared AP 106 and sharing AP 102. The sharing AP 102 and shared AP 104 may use the same preamble field data to populate the preamble 302 of the respective CBF PPDU 312 which is generated and transmitted.

The UHR USIG Overflow subfield 334 may include additional fields such as a spatial reuse subfield 334-f and a number of UHR LTF symbol subfield 334-h. Spatial reuse indicates whether simultaneous transmissions on the same channel is permitted or not is set to zero to indicate it is not permitted. Spatial reuse allows the stations in each BSS to use a less sensitive preamble detection threshold for OBSS frames. The field data of the spatial reuse subfield 334-f which may be indicative of this threshold and set to 15. The number of UHR LTF symbols may be set as a fixed number based on a number of spatial streams (Nss) for the CBF transmission and may be set to two times an initial number of UHR-LTF symbols which is set based on a total number of spatial streams (Nss) in an example. Field data of these fields may be indicated in the trigger frame 206. The sharing AP 102 and shared AP 104 may use the preamble field data to populate the preamble 302 of the respective CBF PPDU 312 which is generated and transmitted. The UHR USIG Overflow subfield 334 may also include a packet extension (PE)-disambiguity subfield 334-k to resolve duration and structure of a packet extension. The field data of the packet extension (PE)-disambiguity subfield 334-k may be predefined, stored in a respective preamble field data memory 142 of the sharing AP 102 and shared AP 106 as part of an initialization process, and not communicated between the sharing AP 102 and shared AP 106 or included in the trigger frame 206. Instead, the field data is defined locally by a transmitting AP to generate the preamble 302 of the PPDU 312 and is the same for the sharing AP 102 and shared AP 104.

The UHR SIG user information content subfield 336 may indicate information of a station associated with a shared AP 104 or sharing AP 102. The UHR SIG user information content subfield 336 may include a station ID field 336-f which identifies the station associated with the UHR SIG user information content subfield 336, a modulation and coding field 336-g, a spatial configuration field 336-h which indicates a number of spatial streams (Nss) for the CBF transmission and a long length LDPC field 336-j. In some embodiments, the AP may determine the Nss for the STA based on a negotiation which defines the field data of the spatial configuration field 336-h. Field data of the station ID field 336-f, the modulation and coding field 336-g, the spatial configuration field 336-h and the long length LDPC field 336-j may be included in the trigger frame 206 and the sharing AP 102 and shared AP 104 may use the field data to generate the preamble 302 of the PPDU 312 which is transmitted by CBF. In some embodiments, the field data of the coding field 336-i may be predefined, stored in a respective preamble field data memory 142 of the sharing AP 102 and shared AP 106 as part of an initialization process, and not communicated between the sharing AP 102 and shared AP 106 or included in the trigger frame 206. The predefined field data may also be the same for the shared AP 106 and sharing AP 102 and set to LDPC.

A respective UHR SIG user information content subfield 336 may be transmitted for each user or station which is to receive the PPDU 312. In one or more embodiments, the sharing AP's associated STA and the shared AP's associated STA may need to uniquely identify in the PPDU 312 the station associated with each of instance of the user information field in the PPDU 312. The identification may indicate a recipient of the UHR SIG user information content subfield 336. The UHR SIG user information content subfield 336 for a station may include a station ID of the station to identify the fields as being associated with the station indicated in the station ID field 336-f. The trigger frame 206 may indicate the station ID for the UHR SIG user information content subfield 336 which is used to generate the preamble 302 of the PPDU 312.

In some embodiments, the station ID may be unique to an AP but different AP's may use a same station ID. The sharing AP 102 and shared AP 104 may negotiate which STA to communicate in the UHR SIG user information content subfields 336 so that the STA-IDs are not the same between selected users in the PPDU 312. In one or more embodiments, the preamble 302 may be defined such that no two STAs have a same STA-ID in a same PPDU 312 transmission. The trigger frame 206 may include respective STA-ID for the STA ID field 336-f for a plurality of instances of the UHR SIG user information content subfields 336 of a UHR-SIG field 318 of different users but the STA-ID for each of the users is not the same. The sharing AP 102 and shared AP 104 may then use the indicated STA-ID to populate the preamble 302 of the respective CBF PPDU 312.

In one or more embodiments, the trigger frame 206 may include respective STA-ID for an STA ID field 336-f for a plurality of instances of the UHR SIG user information content subfields 336 where the STA-ID of a station associated with the shared AP 104 and sharing AP 102 are the same. To distinguish whether the same STA-ID is associated with a sharing AP 102 or shared AP 104, in one or more embodiments, UHR SIG user information content subfield 336 for each station may be defined for transmission over different channels for signal bandwidth greater than 20 MHz in the PPDU 312. To form the PPDU 312, a content channel 1 of the PPDU 312 may be loaded with a sharing AP's STA UHR SIG user information content subfields 336 while a content channel 2 of the PPDU 312 may be loaded with a shared AP's STA UHR SIG user information content subfield 336. The channel 1 and channel 2 may be different 20 MHz transmission channels. The respective UHR SIG user information content subfield 336 for STA of the sharing AP 102 and STA of the shared AP may have a same STA ID in the STA ID field 336-f but because the respective UHR SIG user information content subfield 336 are included on different content channels the respective UHR SIG user information content subfield 336 for STA for a sharing AP 102 and shared AP 104 with a same STA-ID are able to be distinguished for each AP. UHR SIG user information content subfield 336 on content channel 1 is an STA of the sharing AP 102 while UHR SIG user information content subfield 336 on content channel 2 is an STA of the shared AP 104. One or more dummy user-information fields are added in content channel 1 if the number of STAs served by shared AP 104 is more than the number of STAs served by sharing AP 102 so that each content channel carries a same number of user-information. The dummy user information fields may not be associated with any STA in the wireless network 100. In some embodiments, the number of STAs served by sharing AP 102 may be greater than or equal to number of STAs served by the shared AP 104. In this embodiment, the trigger frame 206 may include respective STA-ID for the STA ID field 336-f for a plurality of instances of the UHR SIG user information content subfields 336 of the UHR-SIG field 318 and the STA-ID for an STA associated with the sharing AP 102 and an STA associated with the shared AP 104 may be the same.

In one or more embodiments, UHR SIG user information content subfield 336 of the PPDU 312 may have a bit which indicates whether UHR SIG user information content subfield 336 is for a sharing AP STA or a shared AP STA to distinguish STA of the sharing AP 102 and shared AP 104 having a same STA-ID. Coding field 336-i which is B21 of the UHR SIG user information content subfield 336 and which typically indicates whether LDPC or binary convolutional coding (BCC) coding is to be used for the PPDU 312 may be repurposed for this indication. For example, if the bit is set to 0, then the UHR SIG user information content subfield 336 is associated with the sharing AP 102 BSS color while if the bit is set to 1, then the UHR SIG user information content subfields 336 is associated with the shared AP 104 BSS color. If the STA belongs to sharing AP 102, then only the corresponding UHR SIG user information content subfield 336 belonging to sharing AP 102 will be parsed for STA-ID matching. If the STA belongs to shared AP 104, then only the corresponding UHR SIG user information content subfield 336 belonging to shared AP 104 will be parsed for STA-ID matching. The trigger frame 206 may include field data that identify the STA-ID of an STA and BSS color 336-i which is used to populate the fields of a UHR SIG user information content subfield 336 for each STA. The preamble field data are used to generate the preamble 302 of the respective PPDU 312 transmitted by the sharing AP 102 and shared AP 104.

In one or more embodiments, field data of the validate field, cyclic redundancy code (CRC) field, and tail field of the U-SIG 2 subfield 332 of the U-SIG field 316 may be predefined, stored in a respective preamble field data memory 142 of the sharing AP 102 and shared AP 106 as part of an initialization process, and not communicated between the sharing AP 102 and shared AP 106 or included in the trigger frame 206. The predefined field data may also be the same for the shared AP 106 and sharing AP 102. In one or more embodiments, field data of an interference mitigation (IM) field and disregard field in the UHR-SIG Overflow subfield 334 of the UHR-SIG field 318 may be predefined for the shared AP 102 and sharing AP 104, stored in a respective preamble field data memory 142 of the sharing AP 102 and shared AP 106 as part of an initialization process, and not communicated between the sharing AP 102 and shared AP 106 or included in the trigger frame 206. The predefined preamble field data may also be the same for the shared AP 106 and sharing AP 102. In one or more embodiments, field data of a disregard field of the UHR SIG user information content subfield 336 of the UHR-SIG field 318 may be predefined, stored in a respective preamble field data memory 142 of the sharing AP 102 and shared AP 106 of the sharing AP 102 and shared AP 106 as part of an initialization process, and not communicated between the sharing AP 102 and shared AP 106 or included in the trigger frame 206. The predefined preamble field data may also be the same for the shared AP 106 and sharing AP 102.

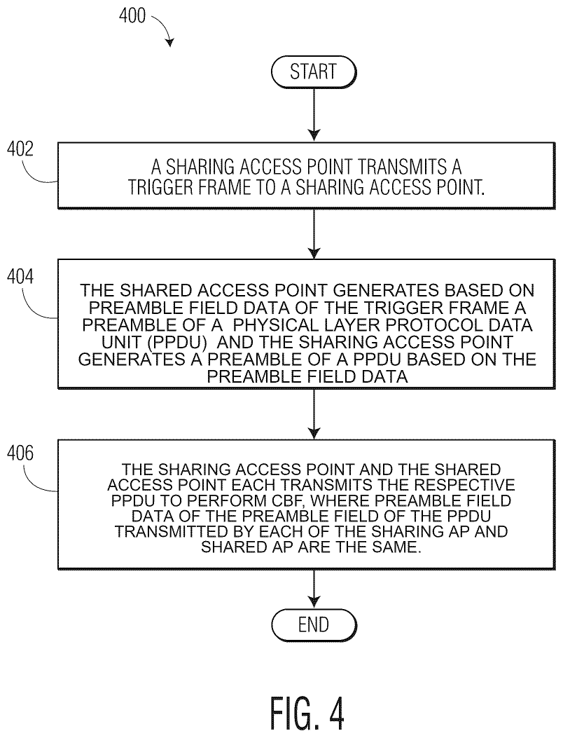

FIG. 4 is an example flow chart 400 of functions for configuration of the fields of the preamble of the PPDU in accordance with one or more embodiments. Functions may be performed by the sharing AP 102 and shared AP 104 in one or more embodiments. At 402, a sharing access point transmits a trigger frame to a sharing access point. The trigger frame may carry preamble field data of the preamble of a PPDU. At 404, the shared access point generates based on preamble field data of the trigger frame a physical layer protocol data unit (PPDU) wherein fields of the preamble of the PPDU for CBF are populated with respective preamble field data. In one or more embodiments, the preamble field data are negotiated between the sharing AP and shared AP prior to generating the PPDU. Further, the sharing AP also generates the preamble of the PPDU based on the preamble field data. At 406, the sharing access point and the shared access point each transmits the respective PPDU to perform CBF, where preamble field data of the preamble of the PPDU transmitted by each of the sharing AP and shared AP are the same. A precoding may be applied to the PPDU. In an embodiment, precoding may be applied to UHR training fields of the PPDU to generate a null spatial beam and precoding may be applied to the data field of the PPDU for beamforming to a station associated with a transmitting AP. Further, no precoder may be applied to the preamble of the PPDU.

In some embodiments, the PPDU that is transmitted may be used for coordinated spatial reuse. The PPDU described herein may not be limited to use in coordinated beamforming. Further the predefined preamble field data may be defined during a configuration of an AP and coordinated to be the same among the APs in the wireless network 100 in an embodiment. The preamble field data as described herein may include data for all fields of the preamble or a portion of the fields of the preamble. In one or more embodiments, the PPDU transmitted by different APs may have preamble field data for all fields of the preamble being the same.

In one or more embodiments, a method for coordinated beamforming (CBF) in accordance with Institute of Electrical and Electronics Engineers (IEEE) 802.11 protocol is disclosed. The method includes: transmitting, by a sharing access point (AP), a trigger frame to a shared access point; generating, by the sharing AP and shared AP, based on preamble field data carried by the trigger frame a respective physical layer protocol data unit (PPDU) wherein the preamble field data are populated in respective fields of a preamble of the respective PPDU, and wherein the preamble field data are negotiated between the sharing AP and shared AP prior to generating the PPDU; and transmitting, by the sharing AP and shared AP, simultaneously in time and frequency the respective PPDU to perform the CBF, wherein the preamble field data in the populated fields of the preamble of the respective PPDU transmitted by the sharing AP and shared AP are the same. In an embodiment, the sharing AP and shared AP transmits in the trigger frame field data of a universal signaling (USIG) field of the preamble which includes a phy version ID field, PPDU bandwidth field, a punctured channel indicator field, and a transmit opportunity (TXOP) field. In an embodiment, a universal signaling (USIG) field of the preamble includes a phy version ID field and a transmit opportunity (TXOP) field, wherein field data of the phy version ID field and TXOP fields are predefined, stored in a respective preamble field data memory of the sharing AP and shared AP, the same for the shared AP and the sharing AP, and not transmitted in the trigger frame, wherein a phy version ID is set to ultra-high reliability (UHR) and a TXOP is set to 127. In an embodiment, the preamble includes a universal signaling (USIG) field including an uplink/downlink field, a PPDU type field indicating a CBF transmission, an ultra high reliability signaling field modulation and coding scheme (UHR-SIG MCS), and a UHR-SIG number of symbols field, wherein field data of the uplink/downlink field, the PPDU type field, UHR-SIG MCS field, and the UHR-SIG number of symbols field are predefined, stored in a respective preamble field data memory of the sharing AP and shared AP, the same for the shared AP and the sharing AP, and not transmitted in the trigger frame; wherein the uplink/downlink field is to be set to downlink, the PPDU type field is to be set to a CBF transmission, the ultra high reliability signaling modulation and coding scheme (UHR-SIG MCS) field is to be set to modulation and coding scheme (MCS) 0, and the UHR-SIG number of symbols field is set based on a number of users. In an embodiment, field data of a BSS color field of a USIG-1 subfield of a USIG field of the preamble is carried in the trigger frame and defines the sharing APs BSS color. In an embodiment, one or more field data in a U-SIG 2 subfield of a U-SIG field and UHR-SIG Overflow subfield of the UHR-SIG field are predefined, stored in a respective preamble field data memory of the sharing AP and shared AP, the same for the shared AP and the sharing AP, and not transmitted in the trigger frame. In an embodiment, a USIG-1 subfield of a USIG field of the preamble defines the shared APs BSS color, wherein an indication of the shared APs BSS color is indicated in the trigger frame and populated in bits B20-B25 of the USIG-1 subfield of the USIG field. In an embodiment, an STA which receives a PPDU compares a BSS color in B7-B12 of the USIG-1 subfield and a BSS color in B20-B25 of the USIG-1 subfield to an associated AP BSS color of the STA. In an embodiment, the STA decodes the PPDU when the associated APs BSS color matches the BSS color in B7-B12 and the STA does not support CBF and the STA decodes the PPDU when the associated APs BSS color matches the BSS color in B7-B12 or B20-B25 and the STA supports CBF. In an embodiment, the sharing AP transmits in the trigger frame field data of a USIG overflow bits subfield of a UHR USIG field of the preamble including a guard interval and long training duration field, a low density parity check (LDPC) extra symbol segment field, a pre-forward error correction (FEC) padding factor field, and a number of users field, wherein the number of users is negotiated between the sharing AP and the shared AP. In an embodiment, a USIG overflow bits subfield of a UHR USIG field of the preamble includes a low density parity check (LDPC) extra symbol segment field and a pre-forward error correction (FEC) padding factor field; and wherein field data of the low density parity check (LDPC) extra symbol segment field and the pre-forward error correction (FEC) padding factor field are predefined, stored in a respective preamble field data memory of the sharing AP and shared AP, the same for the shared AP and the sharing AP, and not transmitted in the trigger frame. In an embodiment, a USIG overflow bits subfield of a UHR USIG field of the preamble includes a number of UHR LTF symbols field, a spatial reuse field, and a packet extension (PE) disambiguity field, wherein the trigger frame includes field data of the number of UHR LTF symbols field and the spatial reuse field but not the packet extension (PE) disambiguity field. In an embodiment, a number of UHR LTF symbols is set to twice that of an initial number of UHR LTF symbols which is set based on a total number of spatial streams (Nss). In an embodiment, a UHR SIG field of the preamble includes a plurality of instances of a UHR user specific content subfield of the UHR SIG field of the preamble wherein each UHR user specific content subfield includes a station identification (STA-ID) field, a MCS field, a spatial configuration field, and a long length LDPC field, and wherein field data of the station identification (STA-ID) field, MCS field, spatial configuration field, and long length LDPC field for each UHR user specific content subfield are defined by the trigger frame. In an embodiment, field data of a coding field of a UHR SIG user specific content subfield of the preamble is included in the trigger frame and the coding field indicates with which STA the UHR SIG user specific content subfield is associated. In an embodiment, the STAs identified in the STA-ID field of the plurality instances of the UHR SIG user specific content subfields of the PPDU do not have a same STA-ID for different STA. In an embodiment, field data of a sharing AP's STA UHR SIG user specific content subfield is transmitted in a UHR-SIG user information content 1 channel and field data of a shared AP's STA UHR SIG user specific content subfield is transmitted in a UHR-SIG user information content 2 channel of the PPDU; and wherein STAs identified in the STA-ID field of the UHR SIG user specific content subfield in the two channels have a same STA-ID for different STA, wherein channel 1 and channel 2 define different 20 MHz transmission channels. In an embodiment, in a UHR SIG user specific content subfield a bit is used to indicate whether the UHR SIG user specific content subfield is for an STA associated with the sharing AP or the STA associated with the shared AP, wherein a first STA with an STA-ID matching the STA ID indicated in the UHR SIG user specific content subfield and associated with a sharing AP parses the UHR SIG user specific content subfield when the bit indicates the UHR SIG user specific content subfield is associated with the sharing AP; and wherein a second STA with an STA-ID matching the STA ID indicated in the UHR SIG user specific content subfield and associated with a shared AP parses the UHR SIG user specific content subfield when the bit indicates the UHR SIG user specific content subfield is associated with the shared AP. In an embodiment, bit B21 of a UHR SIG user specific content subfield indicates whether the UHR SIG user specific content subfield is for an STA associated with the sharing AP or shared AP. In an embodiment, the method further comprises transmitting a CBF invite frame to the shared AP to request suggested preamble field data for the preamble of the PPDU and receiving from the shared AP a CBF response frame with the suggested preamble field data before generating the PPDU, wherein the preamble field data of the PPDU are determined based on the suggested preamble field data.

In another one or more embodiments, a sharing AP to perform coordinated beamforming (CBF) in accordance with Institute of Electrical and Electronics Engineers (IEEE) 802.11 protocol is disclosed. The sharing AP is arranged to transmit a trigger frame from a sharing access point (AP) to a shared access point to cause the shared AP to generate and transmit a first PPDU based on preamble field data carried by the trigger frame, wherein the preamble field data are populated in respective fields of a preamble of the first PPDU, and wherein the preamble field data are negotiated between the sharing AP and shared AP prior to generating the PPDU; generate based on the preamble field data carried by the trigger frame a second physical layer protocol data unit (PPDU) wherein the preamble field data are populated in respective fields of a preamble of the second PPDU; and transmit the second PPDU to perform the CBF, wherein the preamble field data in the populated fields of the preamble of the second PPDU transmitted by the sharing AP and the first PPDU transmitted by the shared AP are the same and the first PPDU and second PPDU are transmitted simultaneously in time and frequency.

A few implementations have been described in detail above, and various modifications are possible. The disclosed subject matter, including the functional operations described in this specification, can be implemented in electronic circuit, computer hardware, firmware, software, or in combinations of them, such as the structural means disclosed in this specification and structural equivalents thereof: including potentially a program operable to cause one or more content processing apparatus such as a processor to perform the operations described (such as a program encoded in a non-transitory computer-readable communication medium, which can be a memory device, a storage device, a machine-readable storage substrate, or other physical, machine readable communication medium, or a combination of one or more of them).

While this specification contains many specifics, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed. Other implementations fall within the scope of the following claims.

What is claimed is:

1. A method for coordinated beamforming (CBF) in accordance with Institute of Electrical and Electronics Engineers (IEEE) 802.11 protocol, the method comprising:
transmitting, by a sharing access point (AP), a trigger frame to a shared access point;
generating, by the sharing AP and shared AP, based on preamble field data carried by the trigger frame a respective physical layer protocol data unit (PPDU) wherein the preamble field data are populated in respective fields of a preamble of the respective PPDU, and wherein the preamble field data are negotiated between the sharing AP and shared AP prior to generating the PPDU; and
transmitting, by the sharing AP and shared AP, simultaneously in time and frequency the respective PPDU to perform the CBF, wherein the preamble field data in the populated fields of the preamble of the respective PPDU transmitted by the sharing AP and shared AP are the same.

2. The method of claim 1, wherein the sharing AP and shared AP transmits in the trigger frame field data of a universal signaling (USIG) field of the preamble which includes a phy version ID field, PPDU bandwidth field, a punctured channel indicator field, and a transmit opportunity (TXOP) field.

3. The method of claim 1, where a universal signaling (USIG) field of the preamble includes a phy version ID field and a transmit opportunity (TXOP) field, wherein field data of the phy version ID field and TXOP fields are predefined, stored in a respective preamble field data memory of the sharing AP and shared AP, the same for the shared AP and the sharing AP, and not transmitted in the trigger frame, wherein a phy version ID is set to ultra-high reliability (UHR) and a TXOP is set to 127.

4. The method of claim 1 wherein the preamble includes a universal signaling (USIG) field comprising an uplink/downlink field, a PPDU type field indicating a CBF transmission, an ultra high reliability signaling field modulation and coding scheme (UHR-SIG MCS), and a UHR-SIG number of symbols field, wherein field data of the uplink/downlink field, the PPDU type field, UHR-SIG MCS field, and the UHR-SIG number of symbols field are predefined, stored in a respective preamble field data memory of the sharing AP and shared AP, the same for the shared AP and the sharing AP, and not transmitted in the trigger frame; wherein the uplink/downlink field is to be set to downlink, the PPDU type field is to be set to a CBF transmission, the ultra high reliability signaling modulation and coding scheme (UHR-SIG MCS) field is to be set to modulation and coding scheme (MCS) 0, and the UHR-SIG number of symbols field is set based on a number of users.

5. The method of claim 1 wherein field data of a BSS color field of a USIG-1 subfield of a USIG field of the preamble is carried in the trigger frame and defines the sharing APs BSS color.

6. The method of claim 1, wherein one or more field data in a U-SIG 2 subfield of a U-SIG field and UHR-SIG Overflow subfield of the UHR-SIG field are predefined, stored in a respective preamble field data memory of the sharing AP and shared AP, the same for the shared AP and the sharing AP, and not transmitted in the trigger frame.

7. The method of claim 5, wherein a USIG-1 subfield of a USIG field of the preamble defines the shared APs BSS color, wherein an indication of the shared APs BSS color is indicated in the trigger frame and populated in bits B20-B25 of the USIG-1 subfield of the USIG field.

8. The method of claim 7, wherein an STA which receives a PPDU compares a BSS color in B7-B12 of the USIG-1 subfield and a BSS color in B20-B25 of the USIG-1 subfield to an associated AP BSS color of the STA.

9. The method of claim 8, wherein the STA decodes the PPDU when the associated AP's BSS color matches the BSS color in B7-B12 and the STA does not support CBF and the STA decodes the PPDU when the associated AP's BSS color matches the BSS color in B7-B12 or B20-B25 and the STA supports CBF.

10. The method of claim 1, wherein the sharing AP transmits in the trigger frame field data of fields of a USIG overflow bits subfield of a UHR USIG field of the preamble comprising a guard interval and long training duration field, a low density parity check (LDPC) extra symbol segment field, a pre-forward error correction (FEC) padding factor field, and a number of users field, wherein the number of users is negotiated between the sharing AP and the shared AP.

11. The method of claim 10, wherein a USIG overflow bits subfield of a UHR USIG field of the preamble comprises a low density parity check (LDPC) extra symbol segment field and a pre-forward error correction (FEC) padding factor field; and wherein field data of the low density parity check (LDPC) extra symbol segment field and the pre-forward error correction (FEC) padding factor field are predefined, stored in a respective preamble field data memory of the sharing AP and shared AP, the same for the shared AP and the sharing AP, and not transmitted in the trigger frame.

12. The method of claim 1, wherein a USIG overflow bits subfield of a UHR USIG field of the preamble comprises a number of UHR LTF symbols field, a spatial reuse field, and a packet extension (PE) disambiguity field, wherein the trigger frame includes field data of the number of UHR LTF symbols field and the spatial reuse field but not the packet extension (PE) disambiguity field.

13. The method of claim 12 wherein a number of UHR LTF symbols is set to twice that of an initial number of UHR LTF symbols which is set based on a total number of spatial streams (Nss).

14. The method of claim 1, a UHR SIG field of the preamble comprises a plurality of instances of a UHR user specific content subfield of the UHR SIG field of the preamble wherein each UHR user specific content subfield includes a station identification (STA-ID) field, a MCS field, a spatial configuration field, and a long length LDPC field, and wherein field data of the station identification (STA-ID) field, MCS field, spatial configuration field, and long length LDPC field for each UHR user specific content subfield are defined by the trigger frame.

15. The method of claim 14, wherein a field data of a coding field of a UHR SIG user specific content subfield of the preamble is included in the trigger frame and the coding field indicates with which STA the UHR SIG user specific content subfield is associated.

16. The method of claim 14, wherein STAs identified in the STA-ID field of the plurality instances of the UHR SIG user specific content subfields of the PPDU do not have a same STA-ID for different STA.

17. The method of claim 14, wherein field data of a sharing AP's STA UHR SIG user specific content subfield is transmitted in a UHR-SIG user information content 1 channel and field data of a shared AP's STA UHR SIG user specific content subfield is transmitted in a UHR-SIG user information content 2 channel of the PPDU; and wherein STAs identified in the STA-ID field of the UHR SIG user specific content subfield in the two channels have a same STA-ID for different STA, wherein channel 1 and channel 2 define different 20 MHz transmission channels.

18. The method of claim 14, wherein in a UHR SIG user specific content subfield a bit is used to indicate whether the UHR SIG user specific content subfield is for an STA associated with the sharing AP or the STA associated with the shared AP, wherein a first STA with an STA-ID matching the STA ID indicated in the UHR SIG user specific content subfield and associated with the sharing AP parses the UHR SIG user specific content subfield when the bit indicates the UHR SIG user specific content subfield is associated with the sharing AP; and wherein a second STA with an STA-ID matching the STA ID indicated in the UHR SIG user specific content subfield and associated with the shared AP parses the UHR SIG user specific content subfield when the bit indicates the UHR SIG user specific content subfield is associated with the shared AP.

19. The method of claim 18, wherein bit B21 of a UHR SIG user specific content subfield indicates whether the UHR SIG user specific content subfield is for an STA associated with the sharing AP or the shared AP.

20. The method of claim 1, further comprising transmitting a CBF invite frame to the shared AP to request suggested preamble field data for the preamble of the PPDU and receiving from the shared AP a CBF response frame with the suggested preamble field data before generating the PPDU, wherein the preamble field data in the PPDU are determined based on the suggested preamble field data.

21. A sharing AP to perform coordinated beamforming (CBF) in accordance with Institute of Electrical and Electronics Engineers (IEEE) 802.11 protocol is arranged to transmit a trigger frame from a sharing access point (AP) to a shared access point to cause the shared AP to generate and transmit a first PPDU based on preamble field data carried by the trigger frame, wherein the preamble field data are populated in respective fields of a preamble of the first PPDU, and wherein the preamble field data are negotiated between the sharing AP and shared AP prior to generating the PPDU; generate based on the preamble field data carried by the trigger frame a second physical layer protocol data unit (PPDU) wherein the preamble field data are populated in respective fields of a preamble of the second PPDU; and transmit the second PPDU to perform the CBF, wherein the preamble field data in the populated fields of the preamble of the second PPDU transmitted by the sharing AP and the first PPDU transmitted by the shared AP are the same and the first PPDU and second PPDU are transmitted simultaneously in time and frequency.
